(19) United States
(12) Patent Application Publication
(10) Pub. No.: US 2016/0182522 A1
(43) Pub. Date: Jun. 23, 2016

(54) CLOUD-BASED DATA PROVIDING METHOD AND SYSTEM

(71) Applicant: WILUS INSTITUTE OF STANDARDS AND TECHNOLOGY INC., Seoul (KR)

(72) Inventors: Jinsam KWAK, Gyeonggi-do (KR); Hyunoh OH, Gyeonggi-do (KR); Juhyung SON, Gyeonggi-do (KR)

(73) Assignee: WILUS INSTITUTE OF STANDARDS AND TECHNOLOGY INC., Seoul (KR)

(21) Appl. No.: 14/910,659

(22) PCT Filed: Jul. 31, 2014
(86) PCT No.: PCT/KR2014/007080

§ 371 Date: Feb. 5, 2016

Related U.S. Application Data
(60) Provisional application No. 61/863,916, filed on Aug. 9, 2013.

(51) Int. Cl. H04L 29/06; H04W 12/06

(52) U.S. Cl. CPC H04L 63/102; H04L 63/0876; H04W 12/06

(57) ABSTRACT

The present invention relates to a cloud based data providing method and a cloud based data providing system, and more particularly, to a method and a system for efficiently providing large size data to a user. To this end, the present invention discloses a data providing method using a temporary cloud of transport means, including: storing user data which is transferred from a source cloud on the temporary cloud of the transport means, the user data being transferred based on boarding information of a user of the transport means; obtaining user authentication information for access to the user data; permitting a user who is boarding the transport means to have access to the temporary cloud, based on the obtained user authentication information; and updating the user data stored in the temporary cloud in accordance with an input of a user who is permitted to have access, the update being performed using an internal communication network of the transport means; establishing a communication link with a base station which is located in an arrival location of the transport means; and transmitting updated information of the user data to the source cloud through the base station in which the communication link is established and a temporary cloud using the same.

### TECHNICAL FIELD

The present invention relates to a cloud based data providing method and a cloud based data providing system, and more particularly, to a method and a system for efficiently providing large size data to a user.

### BACKGROUND ART

Recently, various services for providing a communication environment to a user in transport means such as an aircraft or a ship have been developed. For example, in the case of an aircraft, communication is performed with a base station on the ground using 3G based data communication and a wireless LAN service is provided to passengers in the plane. To this end, the wireless LAN service which is provided in the plane of the aircraft interworks with a network on the ground through a 3G based wireless backhaul. The aircraft may communicate with the terrestrial network through base stations which are set to transmit and receive a radio wave toward the air.

However, in a transoceanic travel situation of the transport means, communication with the base station on the ground is restricted, so that 3G wireless backhaul may not be used. Therefore, the transoceanic environment needs to be supported further using satellite communication means. Further, in the case of the 3G network, a transmission speed is too low to be used as wireless backhaul. Therefore, when a plurality of passengers simultaneously performs communication, there is a restriction that only a small size data based service such as simple web browsing, message transmission, or e-mail transmission may be provided.

As described above, for the passengers using the transport means which may go through a transoceanic travel environment, a method for efficiently solving a problem of disconnection of the communication during the transoceanic travel period is required. However, in the case of the communication service of the related art, huge investment costs are required for a plurality of base stations which are separately set for the transport means, but the provided transmission speed is significantly low as compared with the huge costs.

### DISCLOSURE

### Technical Problem

The present invention has been made in an effort to provide a method for allowing a user who uses the transport means where the communication with the terrestrial network is not smoothly performed to efficiently use large size data, before/after boarding and during onboard.

### Technical Solution

An exemplary embodiment of the present invention provides a data providing method using a temporary cloud of transport means, including: storing user data which is transferred from a source cloud in the temporary cloud of the transport means, in which the user data is transferred based on boarding information of a user of the transport means; obtaining user authentication information for access to the user data; permitting a user who is boarding the transport means to have access to the temporary cloud, based on the obtained user authentication information; and updating the user data stored in the temporary cloud in accordance with an input of a user who is permitted to have access, in which the updating is performed using an internal communication network of the transport means; establishing a communication link with a base station which is located in an arrival location of the transport means; and transmitting updated information of the user data to the source cloud through the base station in which the communication link is established.

Further, another exemplary embodiment of the present invention provides a data providing method using a temporary cloud of transport means, including: storing user data which is transferred from a source cloud in the temporary cloud of the transport means, in which the user data is transferred based on boarding information of a user of the transport means; obtaining user authentication information for access to the user data; permitting a user who is boarding the transport means to have access to the temporary cloud, based on the obtained user authentication information; and providing the user data to the user who is permitted to have access, in which the user data is provided using an internal communication network of the transport means.

Further, a temporary cloud which is mounted in a transport means according to an exemplary embodiment of the present invention may include a storage unit which stores user data; a broadband communication unit which transmits/receives data to/from a source cloud; an internal communication network of the transport means which transmits/receives data to/from a user device; and a cloud server which drives the temporary cloud, in which the cloud server receives the user data from the source cloud and stores the user data in the storage unit, obtains user authentication information for access to the user data, permits the user device to have access to the temporary cloud based on the obtained user authentication information, provides the user data to the user device through the internal communication network of the transport means, and the user data is received based on the boarding information for the transport means of the user.

Another exemplary embodiment of the present invention provides a data transferring method using a temporary cloud a transport means, including: storing user data which is transferred from a base data center in the temporary cloud of the transport means, in which the user data is transferred based on boarding information of a user of the transport means; accessing a destination data center which is mapped to an arrival location of the transport means; and transferring the user data to the destination data center, in which the destination data center is a data center which is different from the base data center.

Further, a data transferring method using a temporary cloud of a transport means includes: storing user data which is transferred from a base data center in a temporary cloud of first transport means, in which the user data is transferred based on boarding information for the first transport means of a user; accessing a temporary cloud of second transport means in a transit terminal of the transport means; and transferring the user data to the accessed temporary cloud of the second transport means, in which the transferring is performed using a backbone network of the transit terminal.

Another exemplary embodiment of the present invention provides a data synchronizing method between a temporary cloud of transport means and a source cloud in which the temporary cloud is driven during the operation of the transport means, the method including: storing user data which is transferred from the source cloud to the temporary cloud; permitting a first user who is boarding the transport means to have access to the temporary cloud; updating the user data stored in the temporary cloud in accordance with an input of a first user who is permitted to have access, in which the updating is performed using an internal communication network of the transport means; receiving an access request message to the source cloud of a second user; and transmitting updated information of the user data of the temporary cloud to the source cloud in real time in accordance with the access to the source cloud of the second user.

A temporary cloud which is mounted in transport means according to another exemplary embodiment of the present invention may include a storage unit which stores user data; a broadband communication unit which transmits/receives data to/from a source cloud; an internal communication network of the transport means which transmits/receives data to/from a user device; and a cloud server which drives the temporary cloud, in which the cloud server receives the user data from the source cloud and stores the user data in the storage unit, permits a first user who is boarding the transport means to have access to the temporary cloud; updates the user data stored in the temporary cloud in accordance with an input of a first user who is permitted to have access, in which the updating is performed using an internal communication network of the transport means, receives an access request message to the source cloud of the second user, and transmits updated information of the user data of the temporary cloud to the source cloud in real time in accordance with the access to the source cloud of the second user.

Further, a temporary cloud which is mounted in transport means may include a storage unit which stores user data; a broadband communication unit which transmits/receives data to/from a source cloud; an internal communication network of the transport means which transmits/receives data to/from a user device; and a cloud server which drives the temporary cloud, in which the cloud server receives the user data from the source cloud and stores the user data in the storage unit, permits a first user who is boarding the transport means to have access to the temporary cloud; provides the user data to the first user through the internal communication network of the transport means, and when the second user updates the user data of the source cloud, receives a message indicating that the second user updates the user data from the source cloud and transmits the message indicating the update to the first user, and when a message requesting to synchronize the updated information of the second user is received from the first user, receives the updated information of the user data of the source cloud from the source cloud, updates the user data of the temporary cloud using the received updated information, and provides the updated user data to the first user.

### Advantageous Effects

According to the exemplary embodiment of the present invention, a cloud based data access environment is provided to a user who uses transport means so that the user efficiently accesses large size data.

According to the exemplary embodiment of the present invention, large size user data is transferred to a temporary cloud of the transport means so that the user may freely use the large size data while onboard of the transport means.

According to another exemplary embodiment of the present invention, the temporary cloud of the transport means is used as transferring means of the user data, so that costs for providing large size private data to the user who uses a remote data center is significantly reduced.

According to still another exemplary embodiment of the present invention, when a passenger of the transport means which is in operation and a general user who uses a terrestrial network use the same cloud data, data may be efficiently synchronized.

### DESCRIPTION OF DRAWINGS

FIG. 1 is a view illustrating an exemplary embodiment in which user data is transferred from a source cloud to a temporary cloud.

FIG. 2 is a view illustrating an exemplary embodiment in which a user uses a temporary cloud while the transport means is in operation.

FIG. 3 illustrates an exemplary embodiment in which data is synchronized between a temporary cloud and a source cloud in an arrival location of the transport means.

FIG. 4 is a flowchart illustrating a data providing method according to an exemplary embodiment of the present invention.

FIG. 5 is a view illustrating an exemplary embodiment in which user data in a home data center is transferred to a destination data center using a temporary cloud of the transport means.

FIG. 6 is a view illustrating an exemplary embodiment in which when a user transfers an aircraft, user data is transferred between temporary clouds of the aircrafts.

FIG. 7 is a view illustrating an exemplary embodiment in which updated information which is created in a destination data center is transferred to a home data center using a temporary cloud of an aircraft.

FIG. 8 is a flowchart illustrating a data transferring method according to an exemplary embodiment of the present invention.

FIG. 9 is a flowchart illustrating a data transferring method according to another exemplary embodiment of the present invention.

FIG. 10 is a view illustrating an exemplary embodiment in which user data is synchronized between a source cloud and a temporary cloud.

FIG. 11 is a view illustrating another exemplary embodiment in which user data is synchronized between a source cloud and a temporary cloud.

FIG. 12 is a flowchart illustrating a user data synchronizing method between a source cloud and a temporary cloud according to an exemplary embodiment of the present invention.

FIG. 13 is a view illustrating a user data synchronizing method of a cloud according to an additional exemplary embodiment of the present invention.

### BEST MODE

Terminologies used in the specification are selected from general terminologies which are currently and widely used as much as possible while considering a function in the present invention, but the terminologies may vary in accordance with the intention of those skilled in the art, custom, or appearance of new technology. Further, in particular cases, the terminologies are arbitrarily selected by an applicant and in this case, the meaning thereof may be described in a corresponding section of the description of the invention. Therefore, it is noted that the terminology used in the specification is analyzed based on a substantial meaning of the terminology and the whole specification rather than a simple title of the terminology.

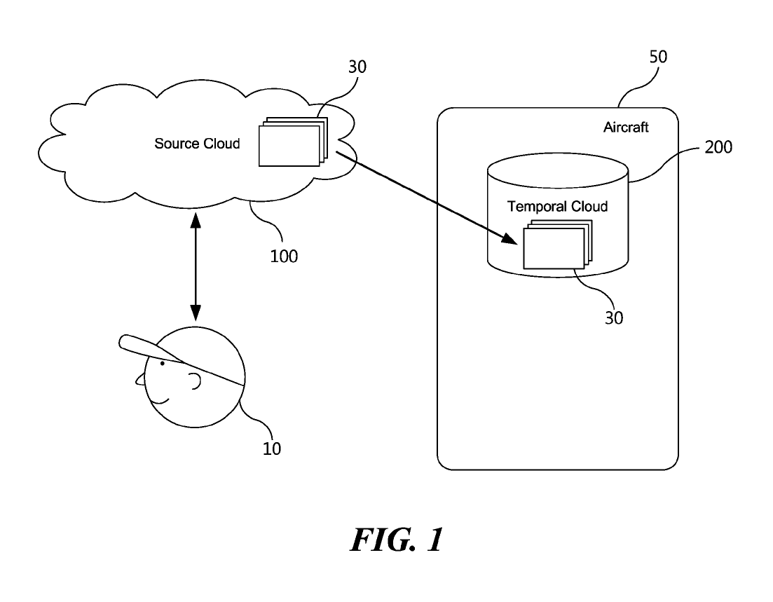

FIGS. 1 to 3 illustrate a data providing method according to an exemplary embodiment of the present invention.

A data providing system according to an exemplary embodiment of the present invention includes a source cloud 100 and a temporary cloud 200. A cloud refers to a technique which combines and provides resources of computers which are located in different physical locations using a virtualization technique and stores various data of a user 10 and distributes and processes the data. In the present invention, the cloud is used as a concept including various types of cloud computing services such as software as a service (SaaS), platform as a service (PaaS), and infrastructure as a service (IaaS). Further, in this specification, the “cloud” may be used as a terminology indicating a cloud server but as a broad meaning, the cloud may have a concept including whole configurations such as a cloud server which provides a cloud service, a storage unit, a communication network (or a communication unit). The cloud service may be provided by at least one data center.

FIG. 1 is a view illustrating an exemplary embodiment in which user data is transferred from a source cloud to a temporary cloud. Referring to FIG. 1, the temporary cloud 200 is mounted in an aircraft 50 which is a kind of transport means. Hereinafter, in the specification, the temporary cloud 200 which is mounted in the aircraft 50 will be described as an example, but the present invention is not limited thereto and may be applied to various transport means such as a ship, in addition to the aircraft 50.

According to the exemplary embodiment of the present invention, in a communication network where a wireless backhaul environment is not good, such as an in-flight aircraft communication network where it is hard to provide a high speed broadband communication environment with the ground or a satellite, the temporary cloud 200 server may be mounted in the aircraft 50 in order to provide a consistent cloud service. More specifically, in order to provide the temporary cloud 200 service, a cloud server, a storage unit, and an in-flight communication network may be mounted in the aircraft 50. Further, the temporary cloud 200 may further include a broadband communication unit to transmit and receive data with an external source cloud 100. According to an exemplary embodiment, the broadband communication unit may use the same communication method (for example, a wireless LAN) as the in-flight communication network and the temporary cloud 200 may perform broadband communication and the in-flight communication with the source cloud 100 using an integrated communication unit.

Before boarding the aircraft 50, the user 10 may request or approve a cloud service provider or an airline to transfer user data 30 to the temporary cloud 200 which is mounted in the aircraft 50. When there is the request or the approval, the cloud service provider transfers the user data 30 from the source cloud 100 to the temporary cloud 200 of the aircraft 50 using a wired/wireless broadband terrestrial network communication (for example, a cellular, a wireless LAN, or a cable) in a terminal (for example, an airport). In the present invention, the source cloud 100 indicates an original cloud which is provided by a data center which is used by a cloud service provider as default. Further, the user data 30 includes private cloud data of the user 10 who uses the cloud service.

As described above, when the user 10 requests or approves to transfer the user data 30 stored in the source cloud 100 before boarding the aircraft 50, the user data 30 may be transferred to the temporary cloud 200 of the aircraft 50 using the high speed broadband communication network in the airport before the aircraft 50 departs. In this case, the used broadband communication network includes a wired network, a near field wireless network, a cellular network, but the present invention is not limited thereto. When there is a plurality of users who requests to transfer the cloud data, the cloud service provider collects user data for the plurality of users to transfer the user data to the temporary cloud 200 of the aircraft 50. The temporary cloud 200 receives the user data 30 using the provided broadband communication unit and stores the user data 30. According to the exemplary embodiment of the present invention, the user data 30 is transferred to the temporary cloud 200 of the aircraft 50, so that the user 10 may freely use the cloud service during the flight of the aircraft 50, which will be described below. In the meantime, in the exemplary embodiment of the present invention, the transferring of the user data 30 from the source cloud 100 to the temporary cloud 200 means duplicating of the user data 30. That is, when the user data 30 is transferred from the source cloud 100 to the temporary cloud 200, the original user data 30 may remain in the source cloud 100.

According to the exemplary embodiment of the present invention, the cloud data may be transferred based on boarding information for the aircraft 50 of the user 10. The boarding information may include departure time/location information, arrival time/location information of the aircraft 50 on which the user 10 is going to board.

More specifically, according to the exemplary embodiment of the present invention, the user data 30 may be transferred to the temporary cloud 200 based on the departure time information of the aircraft 50. For example, when the user 10 reserves a ticket of the aircraft 50, the boarding information of the user 10 may be transmitted to the cloud service provider. If there is an approval of the user 10 of usage of the temporary cloud 200, the cloud service provider is connected to the airline to prepare to transfer the user data 30. According to an exemplary embodiment, the user data 30 may be transferred to the temporary cloud 200 in real time in accordance with ticket reservation of the user 10 and the approval of the user 10. However, in order to transfer the user data 30 to which a latest state is reflected to the temporary cloud 200, according to another exemplary embodiment of the present invention, the user data 30 may be collectively transferred before a predetermined time from the departure time of the aircraft 50. That is, the cloud service provider collects information of people who reserve tickets of the same aircraft 50 among users of the cloud service and transfers the user data of the people who reserve tickets before a predetermined time from the departure time of the aircraft 50. As described above, the temporary cloud 200 of the aircraft 50 collectively receives the cloud data for the plurality of users and individually receives cloud data from a plurality of cloud service providers.

According to another exemplary embodiment of the present invention, the user data 30 may be transferred to the temporary cloud 200 based on the departure location information of the aircraft 50. For example, when the cloud service provider provides a cloud service using a plurality of data centers, a data center which transfers data to the temporary cloud 200 may be determined based on the departure location information of the aircraft 50. That is, a data center which is the closest to the aircraft 50 which transfers the data may transfer the user data 30 to the temporary cloud 200.

As described above, when the user data 30 is transferred to the temporary cloud 200, the user data 30 in the source cloud 100 is frozen. That is, it is restricted to have access to or update the user data 30 of the source cloud 100. The cloud service provider or the temporary cloud 200 transmits a message notifying that the source cloud 100 is restricted to be accessed or updated, to the users 10. After the user data 30 of the source cloud 100 is frozen, only the temporary cloud 200 may permit to have access to or update the user data 30 until the frozen state is released. According to an exemplary embodiment, the user data 30 of the source cloud 100 may be frozen when it is confirmed that the user 10 passes a boarding gate and finally boards the aircraft 50. If the aircraft 50 departs while the user 10 does not board the aircraft 50, the frozen state of the user data 30 of the source cloud 100 may be immediately released. In this case, the temporary cloud 200 deletes the user data 30 which is stored in the storage.

In the meantime, according to an exemplary embodiment of the present invention, authentication information of the user 10 to have access to the user data 30 may be transmitted to the temporary cloud 200. The temporary cloud 200 may obtain the authentication information of the user 10 from a cloud authentication server of the source cloud 100 before the departure of the aircraft 50. The temporary cloud 200 permits the user who is boarding on the aircraft 50 to have access, based on the obtained authentication information of the user 10. The authentication information of the user 10 may be transferred together with the user data 30 or transmitted to the temporary cloud 200 using the terrestrial network communication before the departure of the aircraft 50. Moreover, the temporary cloud 200 may obtain device information which is registered in advance to use the cloud service. When a device which matches the registered device information is detected, the temporary cloud 200 gives the device an access right to have access to the user data 30 of the temporary cloud 200.

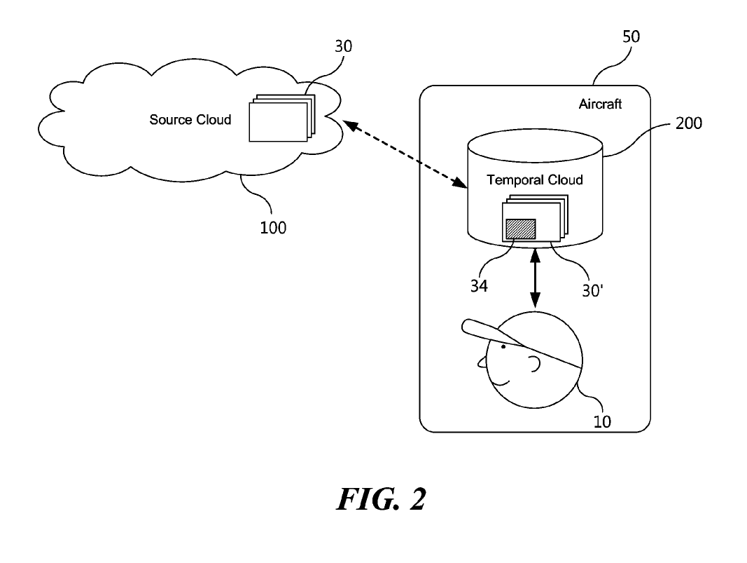

FIG. 2 is a view illustrating an exemplary embodiment in which a user uses a temporary cloud while the aircraft flies. In an exemplary embodiment of the present invention, a terminology “user” has a comprehensive meaning including a digital device which is used by the user to use the cloud service. That is, in the specification, the terminology “user” may be appropriately substituted by a “user device”.

The communication of the user 10 with the terrestrial network may be restricted during the flight of the aircraft 50. In this case, the user 10 may access the user data 30 which is stored in the temporary cloud 200 to use the cloud service. The user 10 who is boarding the aircraft 50 needs to perform user authentication in order to use the temporary cloud 200 which is mounted in the aircraft.

According to the exemplary embodiment, the temporary cloud 200 may permit the user 10 to have access to the temporary cloud 200 based on the user authentication information which is obtained in advance. As described above, the user authentication information may be obtained using the terrestrial network communication before the departure of the aircraft 50. If the temporary cloud 200 obtains the device information which is registered in advance to use the cloud service, the temporary cloud 200 may permit a device (that is, a user device) which matches the registered device information to have access to the user data 30 of the temporary cloud 200.

According to another exemplary embodiment, when the user 10 tries to have access to the cloud, the temporary cloud 200 obtains the user authentication information from a cloud authentication server of the source cloud 100 in real time to perform user authentication. That is, the temporary cloud 200 performs communication with the base station on the ground or the satellite to obtain user authentication information. In this case, the temporary cloud 200 may receive the user authentication information using 3G/4G based communication such as high speed packet access (HSPA), evolution-data optimized (EV-DO), or long term evolution (LTE), but the present invention is not limited thereto. Since the user authentication information is comparatively small-size data, as described above, the user authentication information may be received in real time only when the user 10 requests to use the temporary cloud 200.

The temporary cloud 200 provides the user data 30 only to a user 10 who is permitted to have access. The temporary cloud 200 may provide the cloud service to the user 10 using an in-flight communication network. In this case, the communication network which is used to drive the temporary cloud 200 may include various types of near field communication means such as a wireless LAN (WLAN), Bluetooth, near field communication (NFC), or ZigBee. The temporary cloud 200 may include at least one in-flight communication unit which uses the above-mentioned communication method and provide the user data 30 to the user 10 using the same.

The temporary cloud 200 may update the user data 30 in accordance with an input for the user data 30 by the user 10. That is, the temporary cloud 200 creates updated user data 30′ in accordance with the input of the user 10 and stores the updated user data in a storage unit. The updated user data 30′ includes updated information 34 for the original user data 30 and the updated information 34 indicates information on changed data between the original data and present data. The above interaction between the user 10 and the cloud 200 may be performed through the above-described in-flight communication network.

In the meantime, the temporary cloud 200 performs the communication with the terrestrial base station and the satellite to sporadically exchange data with the source cloud 100. Communication with the terrestrial network which is performed by the temporary cloud 200 during the flight of the aircraft 50 is referred to as sporadic communication in this invention. As described above, the temporary cloud 200 uses the sporadic communication to receive the user authentication information from the cloud authentication server of the source cloud 100. Further, the temporary cloud 200 may transmit/receive the updated information 34 on the user data 30 to/from the source cloud 100 using the sporadic communication. A more specific embodiment thereof will be described below.

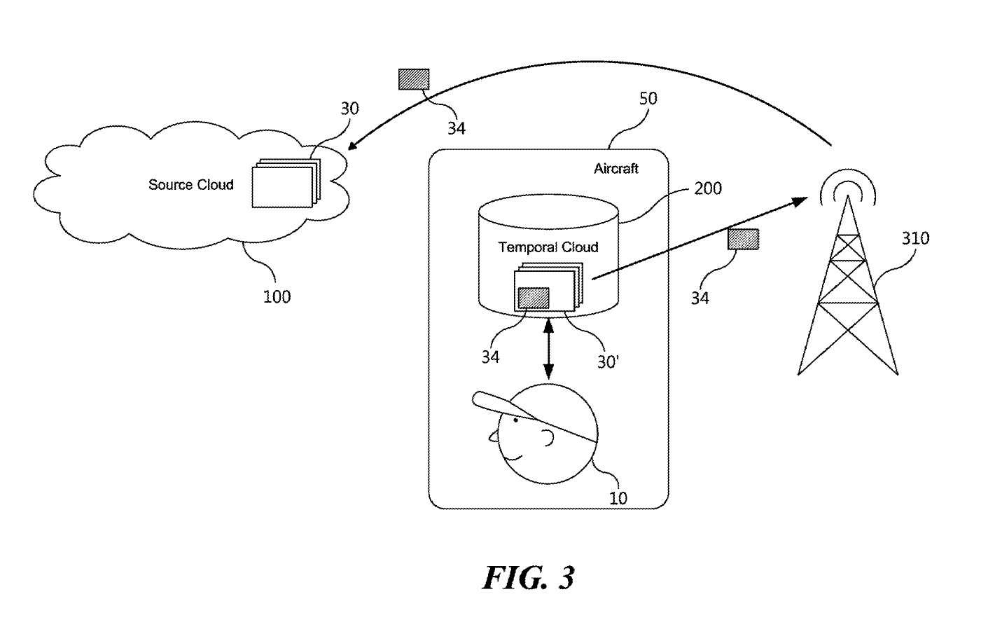

FIG. 3 illustrates an exemplary embodiment in which data is synchronized between a temporary cloud and a source cloud in an arrival location of the aircraft.

When the aircraft 50 arrives at the destination, the temporary cloud 200 tries to communicate with the terrestrial network of the arrival location. In this case, the temporary cloud 200 uses a wired/wireless high speed broadband communication network, which is different from the sporadic communication which is performed during the flight of the aircraft 50. The temporary cloud 200 establishes a communication link with a base station 310 of the arrival location of the aircraft 50 and transmits/receives data to/from the base station 310 where the communication link is established. The temporary cloud 200 transmits/receives data to/from the base station 310 where the communication link is established using the broadband terrestrial network. In the meantime, in this specification, an exemplary embodiment in that the temporary cloud 200 establishes the communication link with the base station 310 of the arrival location has been described, but the present invention is not limited thereto. That is, the temporary cloud 200 performs communication with the terrestrial network using various wired/wireless communication protocols. The temporary cloud 200 establishes the communication link with a wired/wireless access point in accordance with the used communication protocol and transmits/receives the data through the access point.

According to the exemplary embodiment of the present invention, the temporary cloud 200 transmits the updated information 34 of the user data to the source cloud 100 through the base station 310 where the communication link is established. According to an exemplary embodiment of the present invention, the source cloud 100 may be frozen during the flight of the aircraft 50. However, when the communication link between the temporary cloud 200 and the base station 310 in the arrival location is established, the frozen state of the source cloud 100 may be released. The source cloud 100 receives the updated information 34 and updates the user data 30 which is stored in the source cloud 100 using the updated information to synchronize the cloud data.

In the meantime, the temporary cloud 200 according to the exemplary embodiment transmits the updated information 34 based on the boarding information of the user 10. As described above, the boarding information of the user 10 may include departure time/location information and arrival time/location information of the aircraft 50 on which the user 10 boards. Before transmitting the updated information 34, the temporary cloud 200 determines whether the base station 310 where the communication link with the temporary cloud 200 is established is a base station located in the arrival location of the aircraft 50. That is, the temporary cloud 200 determines whether the base station 310 where the communication link is established is an approved base station based on the arrival location information, using the boarding information of the user 10. If the base station 310 where the communication link is established is an approved base station of the arrival location, the temporary cloud 200 transmits the updated information 34 to the base station 310. In contrast, when the base station 310 where the communication link is established is not a base station which is located in the arrival location of the aircraft 50, the temporary cloud 200 does not transmit the updated information 34 to the base station 310. Therefore, it is possible to prevent the updated information 34 from being uploaded when the communication link with a specific base station is temporarily established on an intermediate path before the aircraft 50 arrives at the destination.

As described above, when the updated information 34 is completely transmitted, the temporary cloud 200 may delete the user data 30′ which is stored in the storage unit of the cloud. In this case, the temporary cloud 200 may also delete the authentication information of the user 10. According to an exemplary embodiment, the temporary cloud 200 may transmit a message inquiring whether to delete the user data 30′ stored in the temporary cloud 200 to the user 10. The user 10 determines whether to delete the user data 30′ stored in the temporary cloud 200 based on the message received from the temporary cloud 200 and transmits a message indicating whether to approve the deletion to the temporary cloud 200. The temporary cloud 200 may delete the user data 30′ based on the message indicating whether to approve the deletion, which is received from the user 10. As described above, the user data 30′ may be deleted by the request or approval of the user 10 and when the user data 30′ is completely deleted, the temporary cloud 200 transmits a message indicating that the data is completely deleted, to the user 10. The security of the cloud service may be strengthened by deleting the user data 30′ which is temporarily stored in the temporary cloud 200.

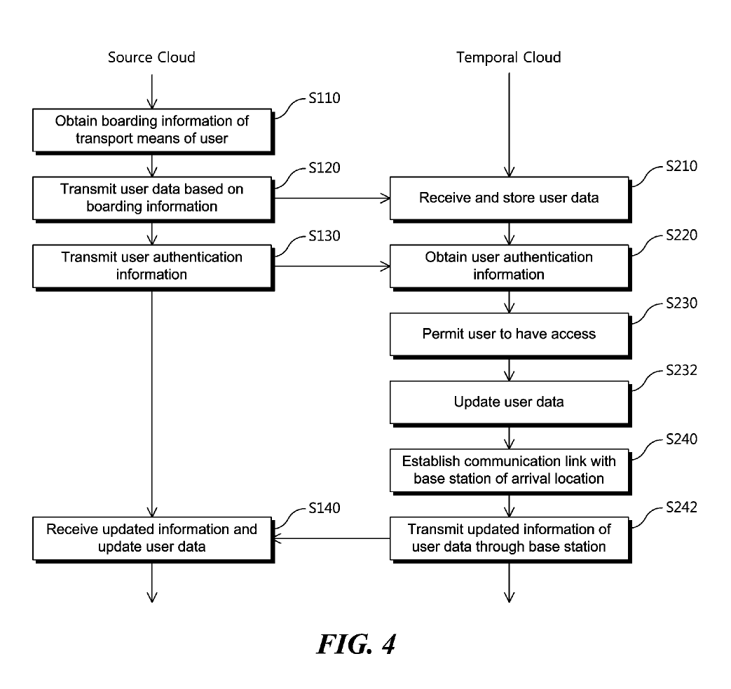

FIG. 4 is a flowchart illustrating a data providing method according to an exemplary embodiment of the present invention. Steps S110 to S140 of FIG. 4 are performed by a source cloud according to an exemplary embodiment and steps S210 to S242 are performed by a temporary cloud according to an exemplary embodiment.

First, the source cloud obtains boarding information of transport means of a user in step S110. When the user reserves a ticket of the transport means, the boarding information of the user may be transmitted to a cloud service provider. The boarding information may include departure time/location information and arrival time/location information of the transport means on which the user is going to board.

Next, the source cloud transmits user data to the temporary cloud based on the obtained boarding information of the user in step S120. The temporary cloud indicates whole configurations which are mounted in the transport means to provide a cloud service and indicates a cloud server which is mounted in the transport means in a narrow sense. The user data includes private cloud data of a user who uses the cloud service. The temporary cloud receives the transmitted user data and stores the user data in step S210. The user data may be transferred using a high speed wired/wireless broadband communication network which is provided in the airport. As described above, when the user data is transferred from the source cloud to the temporary cloud, the original user data may remain in the source cloud.

According to the exemplary embodiment, the user data may be collectively transferred before a predetermined time from the departure time of the transport means. That is, the source cloud determines a time when the data needs to be transferred, using the boarding information (for example, the departure time information) of the user and transfer the user data to the temporary cloud at the determined time. When the plurality of users uses the same temporary cloud, the source cloud may transmit the user data of the users together.

Next, the source cloud transmits the authentication information of the user to the temporary cloud in step S130. The user authentication information is information for accessing the user data and the temporary cloud permits the user to have access to the temporary cloud based on the user authentication information. The user authentication information may be transmitted to the temporary cloud together with the user data before the departure of the transport means or may be transmitted to the temporary cloud during the operation after departure of the transport means. When the user authentication information is transmitted during the operation of the transport means, the source cloud may transmit the user authentication information in accordance with the request for the user authentication information from the temporary cloud. The temporary cloud obtains the transmitted user authentication information in step S220. A specific embodiment for transferring the user data and the user authentication information has been described with reference to FIG. 1.

Next, the temporary cloud permits the user who is boarding the transport means to have access to the temporary cloud based on the obtained authentication information of the user in step S230. The temporary cloud provides the user data to the user who is permitted to have access. The temporary cloud provides the user data using an internal communication network of the transport means (i.e. in-transport-means communication network) and it is described above that the communication network used herein may include various kinds of near field communication units.

Next, the temporary cloud receives an input of the user who is permitted to have access to and updates the user data stored in the temporary cloud in accordance with the input in step S232. The user data may be updated using the internal communication network of the transport means. That is, the temporary cloud may receive user input to change the user data or receive changed information of the user data through the internal communication network of the transport means. When the temporary cloud receives the user input to change the user data, the temporary cloud updates to change the user data based on the received user input. In the meantime, the temporary cloud may receive the change information of the user data from the user (that is, the user device) and the temporary cloud reflects the received change information to the user data to update the user data. In the present invention, the user input which is received by the temporary cloud is used as a concept including a user input to change the user data and the change information of the user data. When the user data is updated, the updated information on the user data may be created in the temporary cloud. The updated information indicates information on changed data between the original data of the user data and the present data.

In the meantime, while the user uses the data using the temporary cloud, the source cloud freezes the user data which is stored in the cloud. That is, the source cloud may restrict access to or update of the user data stored in the cloud. After freezing the user data of the source cloud, the user data may be permitted to be accessed or updated only through the temporary cloud until the frozen state is released. A specific embodiment of step S230 and step S232 have been described with reference to FIG. 2.

Next, the temporary cloud establishes a communication link with a base station which is located in an arrival location as the transport means arrives at the destination in step S240. That is, the temporary cloud may establish the communication link with the base station located in the arrival location in order to use a high speed broadband communication network.

The temporary cloud transmits the updated information of the user data to the source cloud through the base station where the communication link is established in step S242. The temporary cloud of the present invention may transmit the updated information based on the boarding information of the user. That is, the temporary cloud may determine whether the base station where the communication link is established is an approved base station based on the arrival location information of the transport means. When the base station where the communication link is established is the approved base station of the arrival location, the temporary cloud may transmit the updated information to the base station. The source cloud receives the updated information which is transmitted to the base station and updates the user data which is stored in the source cloud using the updated information in step S140. In the meantime, when the base station where the communication link is established is not a base station located in the arrival location of the transport means, the temporary cloud does not transmit the updated information to the base station. When the updated information is completely transmitted, the temporary cloud may delete the user data and the user authentication information which are stored in the storage unit of the cloud. A specific embodiment on establishing the communication link and transmission of the updated information has been described with reference to FIG. 3.

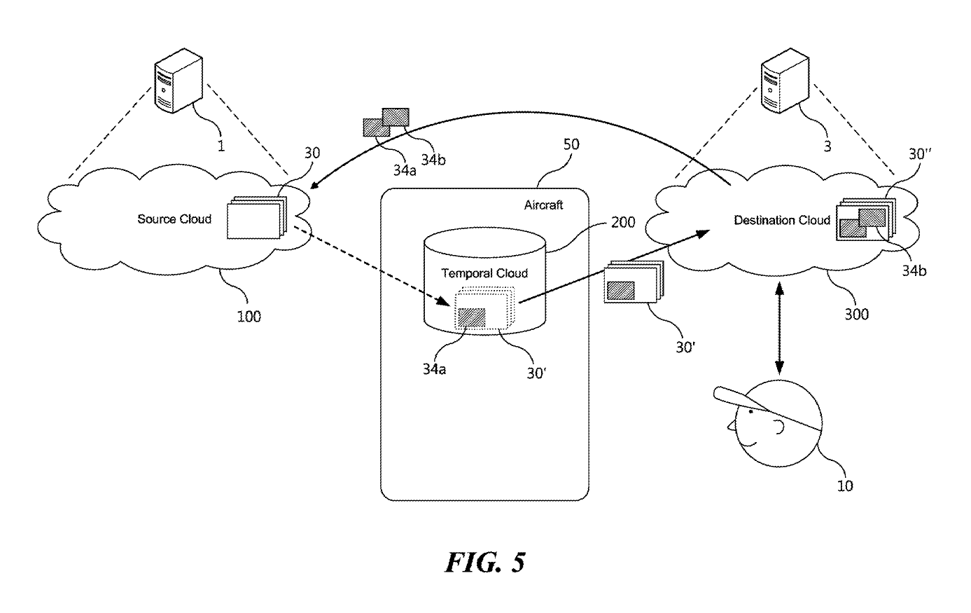

FIGS. 5 to 7 illustrate a data transferring method according to an exemplary embodiment of the present invention. Redundant description of parts of the exemplary embodiments of FIGS. 5 to 7 which are the same as or correspond to the exemplary embodiments of FIGS. 1 to 3 will be omitted.

In many cases, a global cloud service provider operates a separate local data center for every area in order to increase a cloud data access speed of users in countries and areas in the whole world. In this case, when a user who is provided with a cloud service through a specific local data center moves to another country or area, a physical distance between a home data center which is a previously used local data center and a user may be significantly increased. If a cloud service is provided through a home data center which is previously being used, also in the other area to which the user moves, it takes a long time to synchronize the cloud data.

In contrast, the cloud service provider may provide the cloud service using a destination data center which is a local data center in the other area to which the user moves. In this case, the destination data center may be operated by the same cloud service provider as the home data center or a different service provider. However, in this case, there is a problem in that all the cloud data of the user needs to be transferred from the previous home data center to the destination data center. Lots of cost and data traffic are required to transfer large size cloud data using the previous communication network at one time.

According to the exemplary embodiment of the present invention, the cloud data may be efficiently transferred using a temporary cloud which is mounted in the transport means.

FIG. 5 illustrates an exemplary embodiment in which user data in a home data center is transferred to a destination data center using a temporary cloud of the aircraft. A data center is a facility where a computer system, communication equipment, and a storage device are provided and comprehensively indicates a physical device which provides network based services such as a cloud service or a server hosting service. In the exemplary embodiment of FIG. 5, the source cloud 100 is driven by a home data center 1 and a destination cloud 300 is driven by a destination data center 3. In the exemplary embodiment of the present invention, the home data center 1 and the destination data center 3 are physically different data centers.

Referring to FIG. 5, similarly to the above-described embodiment, the source cloud 100 transmits the user data 30 to the temporary cloud 200. In this case, the user data 30 may be transferred from the home data center 1 which drives the source cloud 100 to the temporary cloud 200 of the aircraft 50. The transferring of the user data 30 from the source cloud 100 to the temporary cloud 200 means duplicating of the user data 30. That is, when the user data 30 is transferred from the source cloud 100 to the temporary cloud 200, the original user data 30 may remain in the source cloud 100, that is, in the home data center 1. The temporary cloud 200 which is mounted in the aircraft 50 stores the transferred user data 30 in the storage unit.

According to an exemplary embodiment, the temporary cloud 200 obtains authentication information of the user 10 and permits the user 10 to have access, based on the authentication information during flight of the aircraft 50. The temporary cloud 200 receives an input of the user 10 who is permitted to have access and updates the user data which is stored in the temporary cloud 200 from 30 to 30′ in accordance with the input. When the user data is updated, updated information 34a on the user data 30 may be created in the temporary cloud 200.

In the meantime, when the aircraft 50 arrives at the destination, the temporary cloud 200 establishes a communication link with a base station of the arrival location. In this case, the temporary cloud 200 of the present invention accesses a destination data center 3 which is mapped to the arrival location of the aircraft 50. The destination data center 3 may be a data center which is physically close to the destination of the aircraft 50 and may be operated by the cloud service provider or a different service provider which has a partnership.

When the temporary cloud 200 accesses the destination data center 3, the temporary cloud 200 transfers the user data 30′ to the destination data center 3. In this case, data to be transferred includes all of the updated user data 30′. In the meantime, even though FIG. 5 illustrates an exemplary embodiment in which user data 30 is updated to user data 30′ during the flight of the aircraft 50, when the access to the user data 30 is restricted in the aircraft 50 or the user 10 does not update the user data 30, original user data 30 may be transferred to the destination data center 3. That is, the temporary cloud 200 transfers the original user data 30 or the updated user data 30′ to the destination data center 3. When the data is transferred from the temporary cloud 200 to the destination data center 3, the user data 30 or 30′ stored in the temporary cloud 200 may be deleted.

According to the exemplary embodiment of the present invention, a destination data center 3 in which the temporary cloud 200 accesses and transfers the user data is determined based on boarding information of the user 10. That is, a destination data center 3 to which the temporary cloud 200 transfers the user data may be determined based on arrival location information of the aircraft 50. The cloud service provider may designate a destination data center 3 to which the temporary cloud 200 transfers the user data at the time of arrival of the aircraft 50 in advance based on the arrival location information of the aircraft 50. The destination data center 3 may be a data center of a cloud service provider or a service provider having a partnership which is mapped in advance in accordance with the arrival location of the aircraft 50. According to an exemplary embodiment, the temporary cloud 200 may obtain data transfer information of the user data from the source cloud 100 in advance. The data transfer information is information on a transfer path of the user data and may include information on the destination data center 3 to which the user data should be transferred. According to the exemplary embodiment, the data transfer information may be determined based on the boarding information of the user.

In the exemplary embodiment of FIG. 5, when the user data 30′ is transferred to the destination data center 3, the destination data center 3 provides the destination cloud 300 to the user 10. The user 10 may access the destination cloud 300 and use the user data 30′. Therefore, the user 10 may be seamlessly provided with the cloud service during and before/after boarding the aircraft 50. The destination cloud 300 may receive an input for the user data 30′ by the user 10 and update the user data from 30′ to 30″ in accordance with the input for the user data 30. In this case, new updated information 34b may be created in the destination cloud 300. The destination cloud 300 transmits first updated information 34a which is created in the temporary cloud 200 and second updated information 34b which is created in the destination cloud 300 to the source cloud 100. That is, the first updated information 34a and the second updated information 34b may be transmitted to the home data center 1 which forms the source cloud 100. The source cloud 100 receives the transmitted updated information 34a and 34b and updates the user data 30 which is stored in the source cloud 100 using the updated information to synchronize the cloud data.

In the meantime, according to another exemplary embodiment of the present invention, the user data 30 may be updated through the source cloud 100 while the user 10 uses the destination cloud 300. For example, there may be a plurality of users or user devices which have access rights to the user data of the cloud and some of them may update the user data through the source cloud 100 and the others may update the user data through the destination cloud 300. If updated information on the user data 30 is created in the source cloud 100, the source cloud 100 may transmit the updated information to the destination cloud 300. The destination cloud 300 which receives the updated information reflects the updated information to update the stored user data 30″. The source cloud 100 and the destination cloud 300 exchange updated information on the user data in real time and thus the synchronization of the user data may be bidirectionally performed.

As described above, according to the exemplary embodiment of the present invention, the user 10 who moves a long distance away using transport means is provided with the cloud service through a near data center 3 so that a time delay of the cloud service may be minimized. Further, usage of a network traffic between countries/continents, which may be caused when the user data is transferred from the home data center 1 to the destination data center 3, to smoothly provide the cloud service is minimized, thereby reducing the communication cost.

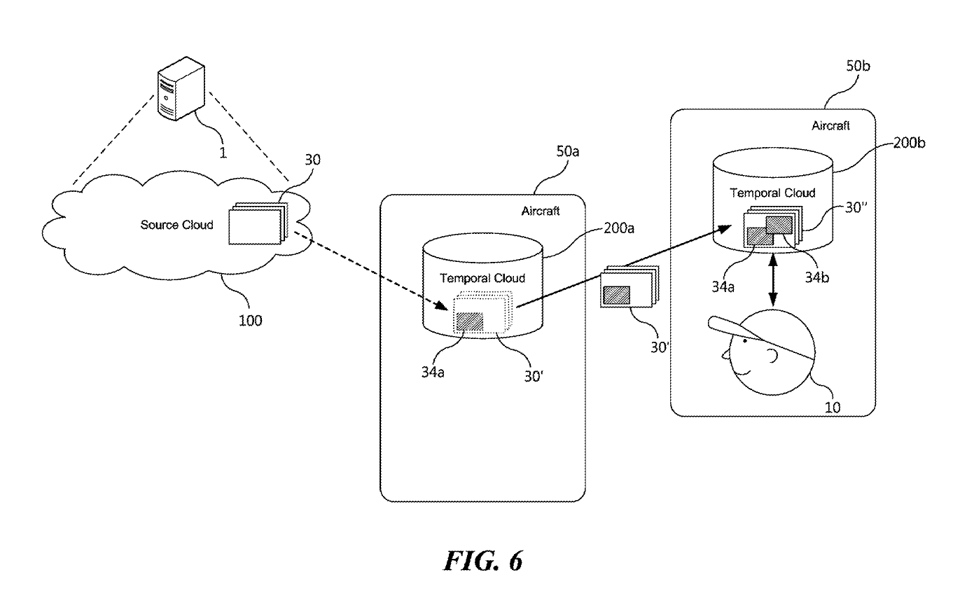

FIG. 6 illustrates an exemplary embodiment in which when a user transfers an aircraft, user data is transferred between temporary clouds of the aircrafts. In an exemplary embodiment of FIG. 6, the user 10 transfers from an aircraft 50a to an aircraft 50b. Reference numerals 50a and 200a denote an aircraft on which the user 10 boards before transferring the aircraft and a temporary cloud which is mounted in the aircraft, respectively, and reference numerals 50b and 200b denote an aircraft on which the user 10 boards after transferring the aircraft and a temporary cloud which is mounted in the aircraft, respectively. Redundant description of parts of the exemplary embodiment of FIG. 6 which are the same as or correspond to the exemplary embodiment of FIG. 5 will be omitted.

When the user 10 transfers from the first aircraft 50a to the second aircraft 50b before arriving at a final destination, the user data 30′ may be transferred from the temporary cloud 200a of the first aircraft 50a to the temporary cloud 200b of the second aircraft 50b. That is, the temporary cloud 200a of the first aircraft 50a transfers the user data 30′ to the temporary cloud 200b of the second aircraft 50b as the first aircraft 50a arrives at a transit location. Even though FIG. 6 illustrates that the updated user data 30′ is transferred, the original user data 30 may be transferred to the temporary cloud 200b of the second aircraft 50b according to an exemplary embodiments.

According to an exemplary embodiment of the present invention, the temporary cloud 200a of the first aircraft 50a may transfer the authentication information of the user 10 and data transfer information in addition to the user data 30′ to the temporary cloud 200b of the second aircraft 50b. Similarly to the above-described exemplary embodiment, the temporary cloud 200b of the second aircraft 50b may permit the user 10 to have access to and update the user data 30′ based on the obtained user authentication information. Further, the data transfer information is information on a transfer path of the user data and may include information on a destination data center (not illustrated) to which the user data should be transferred. That is, the data transfer information includes information on the destination data center which is mapped to an arrival location of the second aircraft 50b and as described above in the exemplary embodiment of FIG. 5, the user data may be transferred to the destination data center at the arrival location of the second aircraft 50b. Besides, according to the exemplary embodiment of FIG. 6, the data transfer information may include information on the temporary cloud 200b of the second aircraft 50b to which the user may transfer. The data transfer information may be determined based on the boarding information of the user.

As described above, when the data is transferred from the temporary cloud 200a of the first aircraft 50a to the temporary cloud 200b of the second aircraft 50b, the temporary cloud 200a of the first aircraft 50a may delete the data (that is, the user data, the user authentication information, etc.) related with the user 10.

The temporary cloud 200a of the first aircraft 50a may transfer the user data 30′ to the temporary cloud 200b of the second aircraft 50b using a backbone network of a transit terminal. That is, the temporary cloud 200a of the first aircraft 50a and the temporary cloud 200b of the second aircraft 50b may be connected to the backbone networks of the transit terminals and transfer the data through the corresponding backbone network.

According to the exemplary embodiment of the present invention, the user data 30′ may be transferred from the temporary cloud 200a of the first aircraft 50a to the temporary cloud 200b of the second aircraft 50b based on the boarding information of the user 10. The boarding information of the user 10 may include not only the departure time/location information and the arrival time/location information but also transit time/location/aircraft information. The temporary cloud 200a of the first aircraft 50a may obtain information on the temporary cloud 200b of the second aircraft 50b to which the user data 30′ should be transferred, from the source cloud 100 in advance. According to an exemplary embodiment, the user data 30′ may be transferred based on the data transfer information of the user data 30′. As described above, the data transfer information may include information on a destination data center to which the user data should be transferred and information on the temporary cloud 200b of the second aircraft 50b. As described above, the temporary cloud 200a of the first aircraft 50a determines the temporary cloud 200b of the second aircraft 50b to which the user data 30′ is transferred, based on the boarding information of the user 10 or the data transfer information and accesses the temporary cloud 200b and transfers the user data 30′ thereto.

In the exemplary embodiment of FIG. 6, when the user data 30′ is transferred to the temporary cloud 200b of the second aircraft 50b, the user 10 accesses the temporary cloud 200b and uses the user data 30′. The temporary cloud 200b of the second aircraft 50b may receive an input for the user data 30′ by the user 10 and update the user data from 30′ to 30″ in accordance with the input. In this case, new updated information 34b may be created in the temporary cloud 200b of the second aircraft 50b. When the second aircraft 50b arrives at a final destination of the user 10, similarly to the exemplary embodiment of FIG. 5, the temporary cloud 200b of the second aircraft 50b transfers the updated user data 30″ to the destination data center.

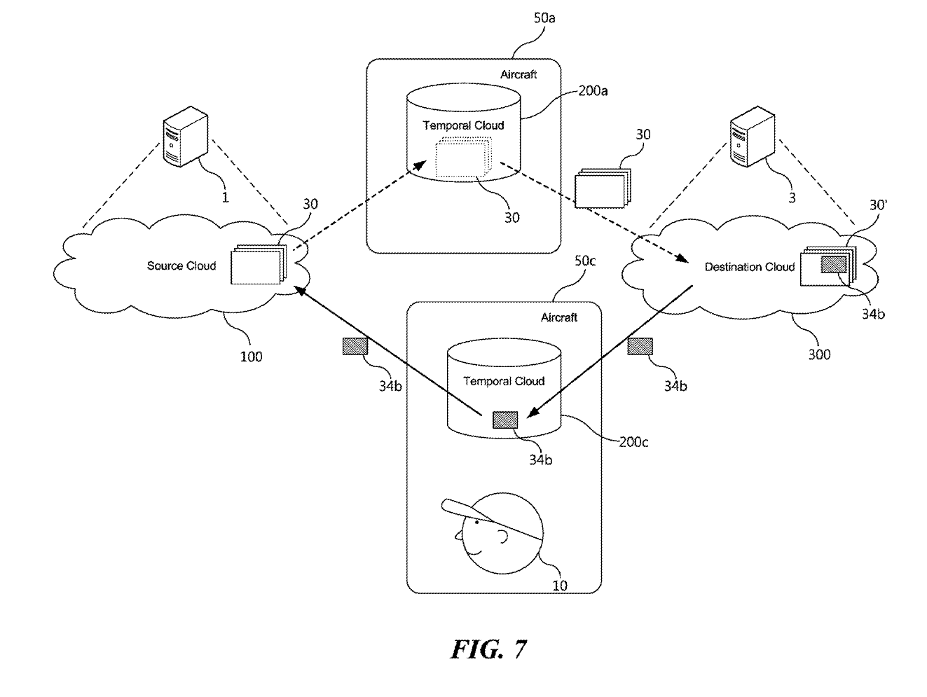

FIG. 7 illustrates an exemplary embodiment in which updated information which is created in a destination data center is transferred to a home data center using a temporary cloud of an aircraft. In the exemplary embodiment of FIG. 7, reference numerals 50a and 200a denote a departing aircraft of the user 10 and a temporary cloud which is mounted in the aircraft, respectively and reference numerals 50c and 200c denote an arriving aircraft of the user 10 and a temporary cloud which is mounted in the aircraft, respectively. Redundant description of parts of the exemplary embodiment of FIG. 7 which are the same as or correspond to the exemplary embodiment of FIG. 5 will be omitted.

According to an exemplary embodiment of the present invention, the user data 30 is transferred using the temporary cloud of the aircraft but it may be restricted to have access to or update the user data 30 in the aircraft. That is, referring to FIG. 7, even though the temporary cloud 200a of the departing aircraft 50a transfers the user data 30 of the home data center 1 to the destination data center 3, it may be restricted to update the user data 30 in the temporary cloud 200a.

As described in the exemplary embodiment of FIG. 5, when it is restricted to have access to or update the user data 30 in the departing aircraft 50a, the original user data 30 may be transferred to the destination data center 3. When the user data 30 is transferred to the destination data center 3, the destination data center 3 provides the destination cloud 300 to the user 10. Therefore, the user 10 may access the destination cloud 300 and use the user data 30. The destination cloud 300 may receive an input for the user data 30 by the user 10 and update the user data from 30 to 30′ in accordance with the input. In this case, updated information 34b on the user data 30 is created in the destination cloud 300.

According to the exemplary embodiment of FIG. 7, the updated information 34b of the user data 30 which is created while the user 10 uses the destination cloud 300 may be transferred to the home data center 1 by the temporary cloud 200c of the arriving aircraft 50c. That is, the temporary cloud 200c of the arriving aircraft 50c receives the updated information 34b of the user data 30 from the destination data center 3 and stores the updated information 34b in a storage unit. When the arriving aircraft 50c arrives at the destination, the temporary cloud 200c accesses the home data center 1 and transmits the updated information 34b to the home data center 1. The home data center 1 which receives the updated information 34b from the temporary cloud 200c of the arriving aircraft 50c updates the user data 30 of the source cloud 100 using the updated information 34b.

In the exemplary embodiment of FIG. 7, the updated information 34b may be transferred based on the boarding information of the arriving aircraft of the user 10. The boarding information of the arriving aircraft may include departure time/location information, arrival time/location information of the arriving aircraft 50c on which the user 10 is going to board. The updated information 34b may be transferred to the temporary cloud 200c of the arriving aircraft 50c based on the departure time information of the arriving aircraft 50c. Further, the updated information 34b may be transferred to the home data center 1 from the temporary cloud 200c based on the arrival time/location information of the arriving aircraft 50c.

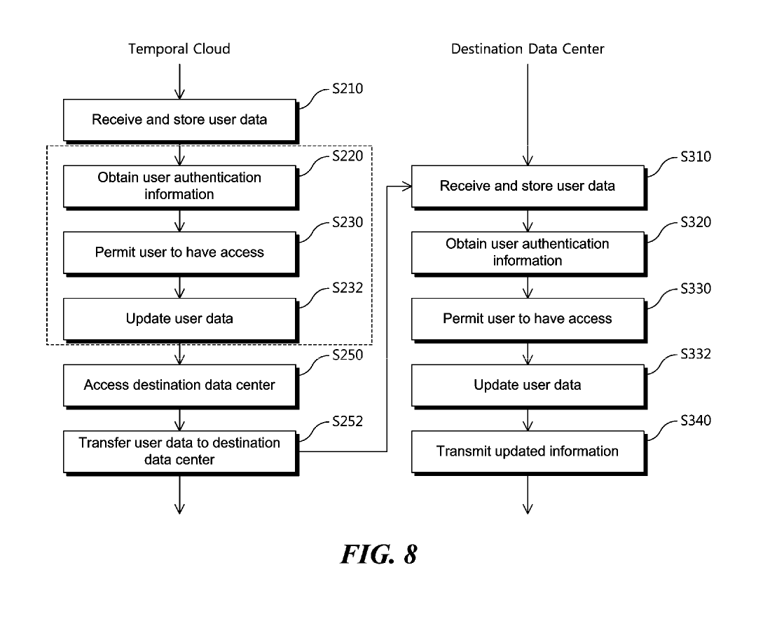

FIG. 8 is a flowchart illustrating a data transferring method according to an exemplary embodiment of the present invention. In FIG. 8, steps S210 to S252 are performed by a temporary cloud of the present invention and steps S310 to S340 are performed by a destination data center (or a destination cloud) of the present invention. In FIG. 8, a specific embodiment of steps S210 to S232 is the same as or similar to the exemplary embodiment of steps S210 to S232 of FIG. 4 and a redundant description will be omitted.

According to an exemplary embodiment of FIG. 8, a temporary cloud of transport means receives user data which is transmitted from a source cloud and stores the user data in step S210. In this case, the user data may be received from a home data center which drives the source cloud. Next, the temporary cloud of the transport means permits the user to have access to the temporary cloud in the transport means and updates the user data through steps S220 to S232. However, when it is restricted to have access to or update the user data in the temporary cloud according to an exemplary embodiment, at least one of steps S220 to S232 may be omitted.

Next, the temporary cloud accesses the destination data center as the transport means arrives at the destination in step S250. The destination data center is a data center which is mapped to the arrival location of the transport means and corresponds to a different data center from the home data center. In the meantime, even though not illustrated in FIG. 8, the temporary cloud may perform step S240 which is described in FIG. 4, to have access to the destination data center. That is, the temporary cloud establishes a communication link with a base station of the arrival location and accesses the destination data center through the base station.

Next, the temporary cloud transfers the user data to the destination data center in step S252. The destination data center receives the transferred user data and stores the user data in step S310. If the user data of the temporary cloud is updated by step S232, the temporary cloud may transfer the updated user data to the destination data center in step S252. When the user data is completely transferred, the user data which is stored in the storage unit of the temporary cloud may be deleted.

According to an exemplary embodiment of the present invention, the destination data center to which the temporary cloud accesses and the user data is transferred is determined based on the boarding information of the user. More specifically, the destination data center may be determined based on the arrival location information of the transport means on which the user boards. The cloud service provider may previously designate the destination data center to which the temporary cloud transfers the user data at the time of arrival of the transport means, based on the arrival location information of the transport means. The destination data center may be a data center of a cloud service provider or a service provider having a partnership which is mapped in advance in accordance with the arrival location of the transport means.

When the user data is transferred to the destination data center, the destination data center provides the destination cloud to the user. To this end, the destination data center obtains the user authentication information corresponding to the user data in step S320 and permits the user to have access to the destination data center based on the obtained user authentication information in step S330. In this case, the user authentication information may be received from the home data center or received from the temporary cloud together with the user data. The destination data center receives an input for the user data by the user and updates the user data of the destination cloud in accordance with the input in step S332. Newly updated information may be created in the destination cloud.

The destination data center transmits the updated information on the user data in step S340. According to the exemplary embodiment of the present invention, the destination data center transmits the updated information to the home data center. In this case, the transmitted updated information may include at least one of first updated information created in the temporary cloud and second updated information created in the destination cloud. According to another exemplary embodiment of the present invention, the destination data center may transmit the updated information to the temporary cloud of the arriving transport means of the user. The temporary cloud of the arriving transport means receives the updated information before departure of the transport means and stores the updated information in the storage unit. When the arriving transport means arrives at the destination, the temporary cloud of the transport means accesses the home data center and transmits the updated information to the home data center. As described above, the home data center which receives the updated information updates the user data of the source cloud using the updated information to synchronize the cloud data.

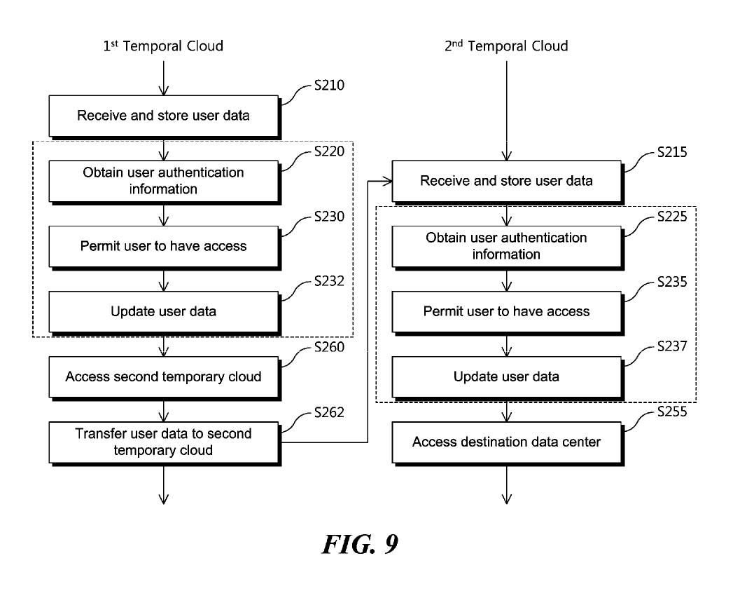

FIG. 9 is a flowchart illustrating a data transferring method according to another exemplary embodiment of the present invention. In FIG. 9, steps S210 to S262 are performed by a first temporary cloud of the present invention and steps S215 to S255 are performed by a second temporary cloud of the present invention. In the exemplary embodiment of FIG. 9, the user transfers from first transport means to second transport means and the first temporary cloud and the second temporary cloud indicate temporary clouds mounted in the first transport means and the second transport means, respectively. In the exemplary embodiment of FIG. 9, steps S210 to S232 of the first transport means are the same as steps S210 to S232 of FIG. 8.

According to an exemplary embodiment of FIG. 9, when the user transfers from the first transport means to the second transport means before arriving at a final destination, the user data is transferred from the first temporary cloud to the second temporary cloud. That is, the first temporary cloud accesses the second cloud when the first transport means arrives at the transit location in step S260 and transfers the user data to the second temporary cloud in step S262. If the user data of the first temporary cloud is updated by step S232, the first temporary cloud may transfer the updated user data to the second temporary cloud in step S262. According to an exemplary embodiment, the first temporary cloud may transfer the authentication information of the user and the data transfer information to the second temporary cloud in addition to the user data. As described above, when the data is completely transferred from the first temporary cloud to the second temporary cloud, the first temporary cloud may delete data (for example, the user data and the user authentication information) related with the user.

According to the exemplary embodiment of the present invention, the first temporary cloud may transfer the user data to the second temporary cloud using a backbone network of the transit terminal. The user data may be transferred from the first temporary cloud to the second temporary cloud based on the boarding information of the user and the boarding information of the user may include transit time/location/transport means information. According to an exemplary embodiment, the user data may be transferred based on the data transfer information of the user data and the data transfer information may include information on the destination data center to which the user data should be transferred and information on the second transport means (or the second temporary cloud).

In the meantime, the second temporary cloud receives the user data from the first temporary cloud and stores the user data in the storage unit in step S215. Next, the second temporary cloud permits the user to have access to the second temporary cloud in the second transport means through steps S225, S235, and S237 and updates the user data. However, when it is restricted to have access to or update the user data in the second temporary cloud according to an exemplary embodiment, at least one of steps S220 to S232 may be omitted.

The second temporary cloud accesses the destination data center as the second transfer means arrives at the destination in step S255. A specific embodiment of step S255 is the same as described in step S250 of FIG. 8. That is, the second temporary cloud accesses the destination data center in the final destination of the user and transfers the user data to the data center. When the user data is completely transferred to the destination data center, the user data which is stored in the storage unit of the second temporary cloud may be deleted.

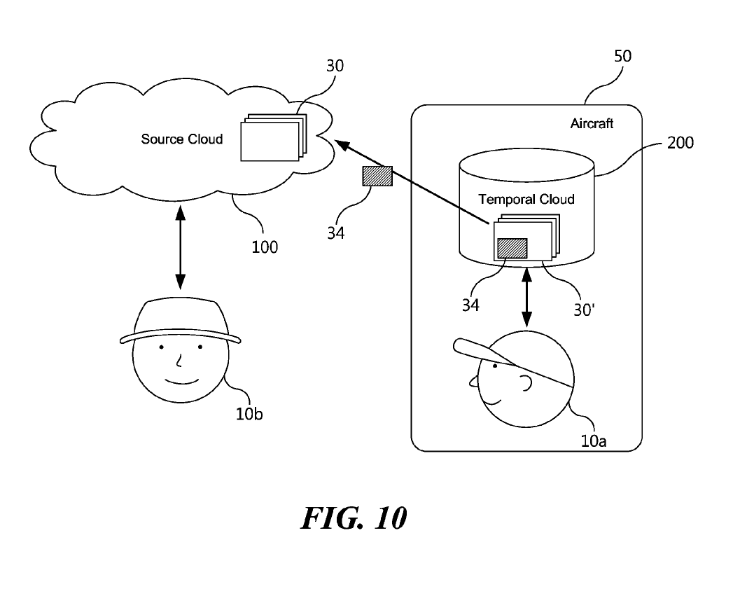

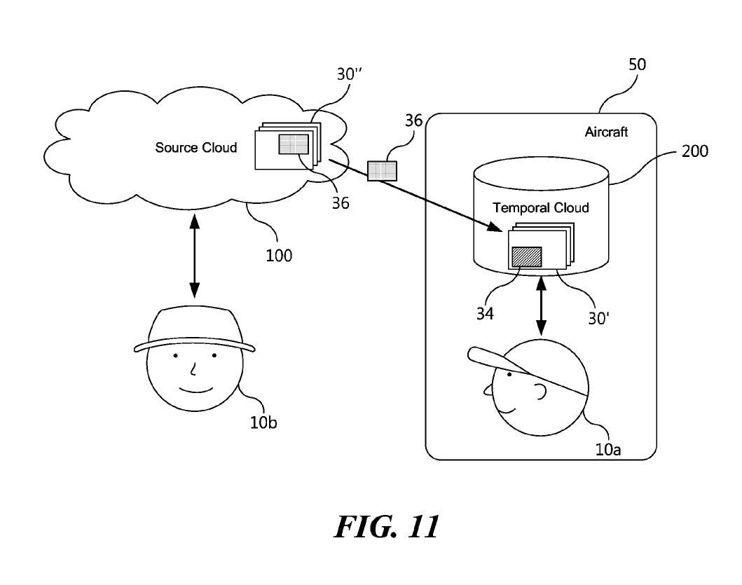

FIGS. 10 and 11 illustrate a synchronizing method of cloud data for a plurality of users who uses the same cloud data. Redundant description of parts of the exemplary embodiments of FIGS. 10 and 11 which are the same as or correspond to the exemplary embodiments of FIGS. 1 to 3 will be omitted. Further, as described above, a terminology “user” in the exemplary embodiments of FIGS. 10 and 11 may refer to a user device which is being used by the user.

FIG. 10 illustrates an exemplary embodiment in which user data is synchronized between a source cloud and a temporary cloud. In the exemplary embodiment of FIG. 10, a first user 10a uses a temporary cloud 200 of an aircraft 50 and user data 30 may be transferred from a source cloud 100 to the temporary cloud 200 before departure of the aircraft 50 for the first user 10a.

According to the exemplary embodiment of FIG. 10, the plurality of users 10a and 10b may be permitted to have access to the same user data 30 of the cloud. That is, the first user 10a accesses the user data 30 through the temporary cloud 200 and updates the user data 30 and the second user 10b accesses the same user data 30 through the source cloud 100.

As described above, the temporary cloud 200 permits the first user 10a to have access to the temporary cloud 200 and updates the user data stored in the temporary cloud 200 to 30′ in accordance with an input of the first user 10a who is permitted to have access. In this case, the updated information 34 for the user data is created in the temporary cloud 200 and the updated information 34 indicates information on changed data between original user data 30 and present user data 30′.

The temporary cloud 200 communicates with a terrestrial network through a ground base station or a satellite. However, according to an exemplary embodiment of the present invention, the temporary cloud 200 may selectively perform data synchronization between the temporary cloud 200 and the source cloud 100 in order to minimize communication between the aircraft and the terrestrial network which consumes large costs. For example, the temporary cloud 200 may not transmit updated information 34 on the user data to the source cloud 100 in a single user mode in which only the first user 10a uses the cloud data. According to another exemplary embodiment, the temporary cloud 200 may sporadically transmit the updated information 34 on the user data to the source cloud 100 in the single user mode.

In the meantime, when the second user 10b accesses the source cloud 100, the single user mode may be switched to a multi user mode in which the first user 10a and the second user 10b use the same cloud data. In the multi user mode, the user data which is stored in the source cloud 100 and the temporary cloud 200 needs to be synchronized at in real time. To this end, the temporary cloud 200 transmits the updated information 34 on the user data to the source cloud 100 in real time. The source cloud 100 may update the user data 30 of the source cloud 100 using the updated information 34 received from the temporary cloud 200. Therefore, user data which is updated by the first user 10a may be provided to the second user 10 who uses the source cloud 100 in real time.

According to an exemplary embodiment of the present invention, whether to permit the second user 10b to have access to the source cloud 100 may be determined by the first user 10a. When the second user 10b requests to have access to the source cloud 100, the source cloud 100 transmits an access request message of the second user 10b to the temporary cloud 200. The temporary cloud 200 which receives the access request message may transmit the message to the first user. The first user 10a may create a message indicating whether to approve the second user 10b to have access in accordance with the access request message. The temporary cloud 100 receives the message indicating whether to approve the second user 10b to have access, from the first user 10a and transmits the message to the source cloud 100. The source cloud 100 may determine access of the second user 10b based on the received message indicating whether to approve the access. If the message indicating whether to approve the access approves the second user 10b to have access, the source cloud 100 approves the second user 10b to have access and gives the access right to the user data 30. However, when the message indicating whether to approve the access rejects the second user 10b to have access, the source cloud 100 restricts the second user 10b to have access to the source cloud or restricts access to the user data 30.

If it is set in advance to permit the second user 10b to have access to the source cloud 100, the temporary cloud 200 may transmit the updated information 34 to the source cloud 100 in real time as soon as the access request message of the second user 10b is received.

In the meantime, even though the first user 10a and the second user 10b access the temporary cloud 200 and the source cloud 100, respectively, individual data which is used by the users may be different from each other. Therefore, the above-described exemplary embodiment for the access and the access request of the second user 10b to the source cloud 100 may be modified to an exemplary embodiment for the access and the access request of the second user 10b to the user data 30 of the source cloud 100. That is, the multi user mode in FIG. 10 may be applied only when the first user 10a and the second user 10b use the same user data in the cloud, according to the exemplary embodiment.

FIG. 11 illustrates another exemplary embodiment in which user data is synchronized between a source cloud and a temporary cloud. Redundant description of parts of the exemplary embodiment of FIG. 11 which are the same as or correspond to the exemplary embodiment of FIG. 10 will be omitted.

According to an exemplary embodiment of the present invention, in a multi user mode, the source cloud 100 receives an input of a second user 10b and updates user data to 30″ in accordance with the input. In this case, updated information 36 on the user data may be created in the source cloud 100. Further, in order to synchronize data between the source cloud 100 and the temporary cloud 200 in real time, the updated information 36 created in the source cloud 100 may be transmitted to the temporary cloud 200. That is, when the second user 10b updates the user data of the source cloud 100, the source cloud 100 may transmit the updated information 36 on the user data 30 to the temporary cloud 200.

In this case, data synchronization between the source cloud 100 and the temporary cloud 200 may be selectively performed in order to minimize communication between the aircraft and the terrestrial network which consumes large costs. According to an exemplary embodiment, the source cloud 100 may transmit the updated information 36 created in the source cloud 100 to the temporary cloud 200 only when there is agreement of the first user 10a. More specifically, the source cloud 100 may transmit a message indicating that the second user 10b has updated data, to the temporary cloud 200. The temporary cloud 200 receives the message indicating that the second user 10b has updated data and transmits the message to the first user 10a. The first user 10a receives the message and determines whether to synchronize the updated information 36 created in the source cloud 100 in accordance with the message. If a message for a synchronization request of the updated information 36 of the user data is received from the first user 10a, the temporary cloud 200 may transmit the synchronization request message to the source cloud 100. The source cloud 100 which receives the synchronization request message transmits the updated information 36 created in the source cloud 100 to the temporary cloud 200 and the temporary cloud 200 receives the updated information. The temporary cloud 200 updates the user data 30′ of the temporary cloud 200 using the received updated information 36 to synchronize the data.

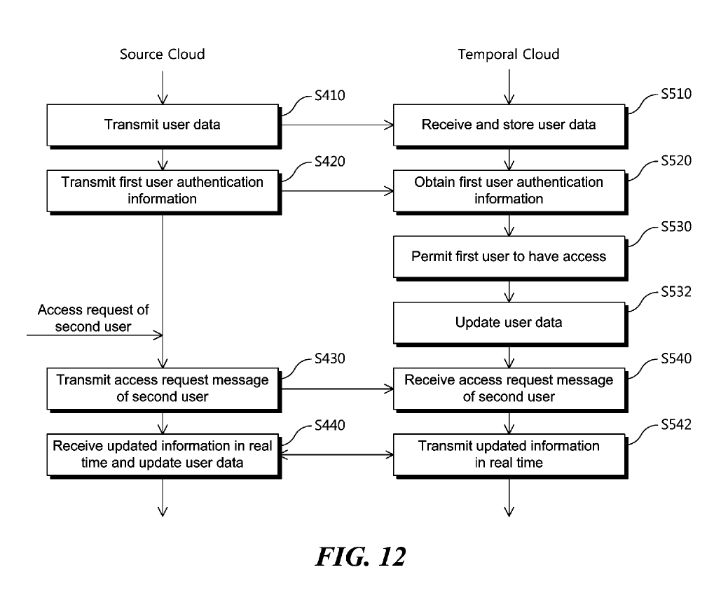

FIG. 12 is a flowchart illustrating a user data synchronizing method between a source cloud and a temporary cloud according to an exemplary embodiment of the present invention. In FIG. 12, steps S410 to S440 are performed by a source cloud of the present invention and steps S510 to S542 are performed by a temporary cloud of the present invention. Redundant description of parts of the exemplary embodiment of FIG. 12 which are the same as or correspond to the exemplary embodiment of FIG. 4 will be omitted.

First, a source cloud transmits user data to a temporary cloud in step S410. In this case, as described above, the user data may be transmitted to the temporary cloud based on boarding information of a user. The temporary cloud receives the transmitted user data and stores the user data in step S510. Specific embodiments of steps S410 and S510 are the same as the exemplary embodiment of steps S110, S120, and S210 described in FIG. 4.

Next, the source cloud transmits authentication information of a first user who is boarding a transport means to the temporary cloud in step S420 and the temporary cloud obtains the transmitted authentication information of the first user in step S520. As described above, the authentication information of the first user is information to determine whether to permit the first user to have access to the user data.

Next, the temporary cloud permits the first user who is boarding the transport means to have access to the temporary cloud based on the obtained authentication information of the user in step S530. The temporary cloud receives an input of the first user who is permitted to have access to and updates the user data stored in the temporary cloud in accordance with the input in step S532. In this case, the temporary cloud provides the user data to the first user using an internal communication network of the transport means and updates the user data in accordance with the input of the first user. Specific embodiments of steps S420 and S520 to S532 are the same as the exemplary embodiment of steps S13, and S220 to S232 described in FIG. 4.

In the meantime, according to an exemplary embodiment of the present invention, the second user may make an access request to the source cloud while the first user uses the temporary cloud. The source cloud transmits the access request message of the second user to the temporary cloud in accordance with the access request of the second user in step S430. The temporary cloud receives the access request message of the second user in step S540 and synchronizes the data with the source cloud based on the received message. That is, the temporary cloud transmits the updated information on the user data of the temporary cloud to the source cloud in real time in step S5420. The source cloud receives the updated information from the temporary cloud in real time and updates the user data of the source cloud using the received updated information in step S440.

According to an exemplary embodiment of the present invention, whether to permit the second user to have access to the source cloud may be determined by the first user. That is, the temporary cloud transmits the access request message of the second user which is received from the source cloud to the first user and receives a message indicting whether to approve the second user to have access, from the first user. Whether the second user accesses the source cloud may be determined based on the message indicating whether to approve the access. The temporary cloud may transmit the message indicating whether to approve the access to the source cloud. In the meantime, when it is set in advance to permit the second user to have access to the source cloud, the source cloud may permit the second user to have access in accordance with the access request of the second user and the temporary cloud may transmit the updated information on the user data of the temporary cloud to the source cloud immediately in accordance with the reception of the access request message of the second user, in real time.

According to an exemplary embodiment of the present invention, after permitting the access of the second user, the data may be bidirectionally synchronized between the source cloud and the temporary cloud. That is, when the second user updates the user data in the source cloud, the updated information created in the source cloud may be transmitted to the temporary cloud in real time. The temporary cloud updates the user data of the temporary cloud using the updated information received from the source cloud.

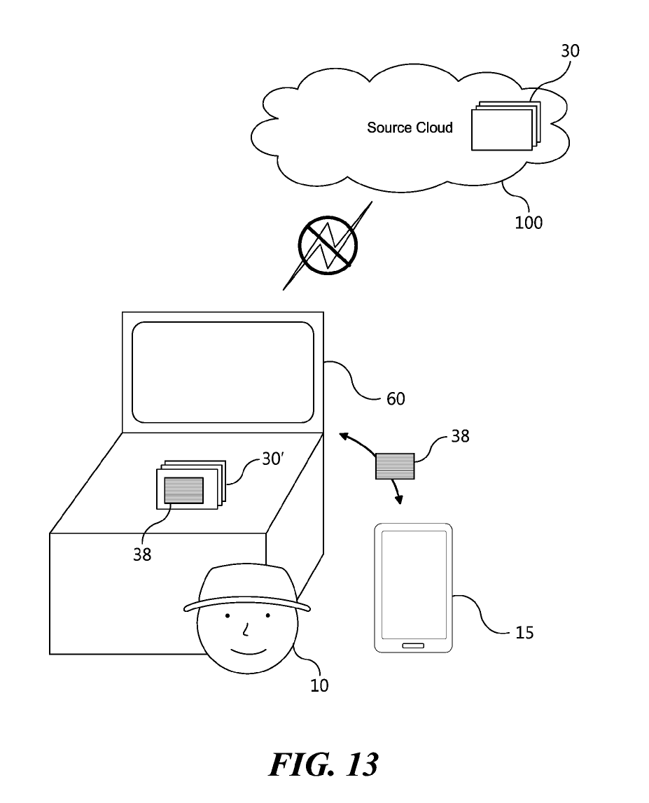

FIG. 13 illustrates a user data synchronizing method of a cloud according to an additional exemplary embodiment of the present invention. Redundant description of parts of the exemplary embodiment of FIG. 13 which are the same as or correspond to the above described exemplary embodiments will be omitted.

According to an exemplary embodiment of FIG. 13, a user 10 may use user data 30 of a cloud 100 using a public client device 60. In this case, the public client device 60 may create updated user data 30′ in accordance with an input of the user 10. The public client device 60 transmits updated information between the user data 30′ and user data 30 of the source cloud 100 to synchronize clouds. However, when a quantity of the updated information for synchronizing the data is large, it may take a long time to synchronize the data. If the user 10 wants to finish the usage of the public client device 60 before completing the data synchronization, inconvenience may be caused. Un-synced updated information 38 which is not synchronized may remain in the public client device 60.

According to the exemplary embodiment of the present invention, the un-synced updated information 38 may be transferred to a private device 15 of the user 10. That is, in a situation when it is difficult to directly transmit the data from the public client device 60 to the cloud 100, the updated information 38 is transferred to the private device 15 of the user 10. In this case, the situation when it is difficult to directly transmit the data may include a case when the user 10 tries to log out from the public client device 60 which is being used by the user, a case when communication connection between the public client device 60 and the cloud 100 is disconnected, and a case when an expected time to transmit the updated information exceeds a predetermined time, but the present invention is not limited thereto. The data may be transferred from the public client device 60 to the private device 15 by various wired/wireless communication protocols such as 3G, 4G, LTE, or Ethernet. Such data transferring may be controlled by the public client device 60 or performed by a control signal of the cloud 100. In the exemplary embodiment of FIG. 13, the private device 15 of the user 10 may include a device which is designated by the user 10 to transfer the data or a device which is registered in advance in the cloud 100.

As described above, when the updated information 38 is completely transmitted, the user data 30′ stored in the public client device 60 may be deleted. According to an exemplary embodiment, the public client device 60 or the cloud 100 may transmit a message inquiring whether to delete the user data 30′ stored in the public client device 60 to the private device 15 of the user 10. The user 10 may determine whether to delete the user data 30′ through the private device 15 and the private device 15 transmits a message indicating whether to approve the deletion to the public client device 60. The public client device 60 may delete the user data 30′ based on the received message indicating whether to approve the deletion. In the meantime, whether to approve to delete the user data 30′ stored in the public client device 60 may be directly input to the public client device 60. When the user data 30′ is completely deleted, the public client device 60 may transmit a message indicating that the deletion is completed to the private device 15 of the user 10.

In the meantime, the updated information 38 which is transmitted to the private device 15 of the user 10 may be transmitted to the cloud 100 through a separate communication network. For example, the private device 15 may transmit the updated information 38 to the cloud 100 using a communication unit which is provided in the device. The cloud 100 which receives the updated information 38 from the private device 15 updates the user data 30 using the updated information 38.

The present invention has been described above through specific embodiments, but change or modification will be made by those skilled in the art without departing from the object and the scope of the present invention. Accordingly, if it is easily inferred by those skilled in the art from the detailed description and the exemplary embodiment of the present invention, it is interpreted to be covered by the scope of the present invention.

### MODE FOR INVENTION

As above, related features have been described in the best mode.

### INDUSTRIAL APPLICABILITY

The present invention can be applied to a cloud service, a system for providing thereof and various digital devices using the same.

1. A data providing method using a temporary cloud of transport means, the method comprising:
storing user data which is transferred from a source cloud in the temporary cloud of the transport means, the user data being transferred based on boarding information for the transport means of a user;
obtaining user authentication information for access to the user data;
permitting a user who is boarding the transport means to have access to the temporary cloud, based on the obtained user authentication information;
updating the user data stored in the temporary cloud in accordance with an input of a user who is permitted to have access, the update being performed using an internal communication network of the transport means;
establishing a communication link with a base station which is located in an arrival location of the transport means; and
transmitting updated information of the user data to the source cloud through the base station in which the communication link is established.

2. The method of claim 1, wherein the boarding information includes departure time information of the transport means and the user data is transferred to the temporary cloud based on the departure time information of the transport means.

3. The method of claim 1, wherein the boarding information includes arrival location information of the transport means and the updated information is transmitted when the base station in which the communication link is established is an approved base station based on the arrival location information.

4. The method of claim 1, further comprising:
deleting the user data stored in the temporary cloud subsequent to the transmitting of the updated information.

5. The method of claim 1, wherein the transmitted updated information is information of changed data between original data and present data.

6. A data providing method using a temporary cloud of transport means, the method comprising:
storing user data which is transferred from a source cloud in the temporary cloud of the transport means, the user data being transferred based on boarding information of a user of the transport means;
obtaining user authentication information for access to the user data;
permitting a user who is boarding the transport means to have access to the temporary cloud, based on the obtained user authentication information; and
providing the user data to the user who is permitted to have access, the user data being provided using an internal communication network of the transport means.

7. A temporary cloud which is mounted in transport means, the temporary cloud comprising:
a storage unit configured to store user data;
a broadband communication unit configured to transmit/receive data to/from a source cloud;
an internal communication network of the transport means configured to transmit/receive data to/from a user device; and
a cloud server configured to drive the temporary cloud,
wherein the cloud server is further configured to:
receive the user data from the source cloud and store the user data in the storage unit,
obtain user authentication information for access to the user data,
permit the user device to have access to the temporary cloud based on the obtained user authentication information, and
provide the user data to the user device through the internal communication network of the transport means,
and wherein the user data is received based on boarding information for the transport means of the user.

8-16. (canceled)

17. The temporary cloud of claim 7,
wherein the cloud server is further configured to:
receive user data from the source cloud and store the user data in the storage unit,
permit a first user who is boarding the transport means to have access to the temporary cloud,
update the user data stored in the temporary cloud in accordance with an input of a first user who is permitted to have access, the update being performed using an internal communication network of the transport means,
receive an access request message to the source cloud of the second user, and
transmit updated information of the user data of the temporary cloud to the source cloud in real time in accordance with the access to the source cloud of the second user.

18. The temporary cloud of claim 7,
wherein the cloud server is further configured to:
receive user data from the source cloud and store the user data in the storage unit,
permit a first user who is boarding the transport means to have access to the temporary cloud,
provide the user data to the first user through the internal communication network of the transport means, and
when the second user updates the user data of the source cloud, receive a message indicating that the second user updates the user data from the source cloud and transmit the message indicating the updating to the first user, and
when a message requesting to synchronize the updated information of the second user is received from the first user, receive the updated information of the user data of the source cloud from the source cloud, update the user data of the temporary cloud using the received updated information, and provide the updated user data to the first user.
